(19) United States
(12) Patent Application Publication
(10) Pub. No.: US 2005/0058457 A1
(43) Pub. Date: Mar. 17, 2005

(54) Method and apparatus for optical noise cancellation

(76) Inventors: Trevor MacDougall, Simsbury, CT (US); Domino Taverner, Delray Beach, FL (US)

Correspondence Address: MOSER, PATTERSON & SHERIDAN, L.L.P., 3040 POST OAK BOULEVARD, SUITE 1500, HOUSTON, TX, 77056-6582, US

(21) Appl. No.: 10/662,969

(22) Filed: Sep. 15, 2003

(51) Int. Cl. H04B 10/12

(52) U.S. Cl. 398/149

(57) ABSTRACT

A method and apparatus for removing optical noise from an optical system. A light source produces optical signals applied to a remote optical element that produces reflected optical signals and is subject to optical background noise such as reflections from splices and optical connections. Part of the reflected optical signals and at least some of the background noise is applied to a receiver. The receiver output is analyzed to determine either the amount of noise (if broadband) or the frequency components of the noise. If broadband, the noise is subtracted from the composite signal, thus increasing the signal to noise ratio. If periodic, the frequency components of the noise are gated out of the receiver output.

### BACKGROUND OF THE INVENTION

1. Field of the Invention

This invention relates to optical sensor systems. More particularly, this invention relates to a technique for reducing noise in fiber optic systems.

2. Description of the Related Art

Fiber Bragg grating (FBG) elements have been successfully used as sensors in inhospitable locations such as down hole in oil wells. An FBG element is usually formed by photo-induced periodic modulation of the refractive index of an optical fiber's core. An FBG element is highly reflective to light having wavelengths within a narrow bandwidth centered at a wavelength that is referred to as the Bragg wavelength. While wavelengths that are very close to a Bragg wavelength are highly reflected, other wavelengths are passed without reflection. Since the Bragg wavelength is dependent on physical parameters such as temperature and strain that alter the refractive index of the FBG element, an FBG element can be used to measure such parameters. After proper calibration, the Bragg wavelength can be used as an absolute measure of those physical parameters.

FBG sensor systems typically include a tunable laser that interrogates FBG elements by scanning a light beam across an optical spectrum that includes the Bragg wavelengths of the FBG elements. Alternatively, a broadband light source/tunable filter combination can be used in place of the tunable laser. In either case, the scanning light beam produces reflections from the FBG elements. Those reflections are characterized by a spectral response of light intensity verses wavelength. Since the spectral response amplitude peaks correspond to the Bragg wavelengths, by determining physical parameter induced changes in the wavelengths that produce amplitude peaks the physical parameter or parameters of interest can be measured.

Highly useful features of FBG sensor arrays include that multiple FBG elements can be formed within a single optical fiber; multiple optical fibers can be sensed using the same scanning light; and that FBG sensor arrays can be very long, often many kilometers in length. To benefit from multiple FBG elements within an FBG sensor arrays the individual FBG elements should have unique Bragg wavelengths. This prevents wavelength resolution conflicts. The ability to have very long sensor arrays enables a scanning light source to be physically located a long way from the FBG elements.

While very long sensor arrays can be useful, they can present problems to system designers. For example, long optical fibers can have discontinuities such as optical connections and splices that can produce reflections of their own. Such reflections produce spurious optical noise signals that can lead to a reduction in measurand resolution. Indeed, reflections from one connection or splice can be reflected by other connections and splices. With incoherent light, the discontinuities produce an intensity background noise level. More ominously, with coherent light, such as that produced by laser light sources, such discontinuities can produce periodic signals that can interfere with the Bragg element reflections.

Therefore, there is a need in the art for a method and apparatus that reduces noise in fiber Bragg grating sensor systems.

### SUMMARY OF THE INVENTION

The principles of the present invention enable background noise cancellation in fiber Bragg grating sensors and in other optical elements.

An apparatus that is in accord with the principles of the present invention includes a light source for producing an optical signal. The optical signal from the light source, which can be a tunable laser or a broadband light source coupled to a tuned optical filter, is applied to a remote optical element that is subject to optical background noise. The optical signal is modified by the optical element and is reflected back to (or passes to) a receiver. The reflected optical signal is analyzed to determine the amount of noise. If the noise is broadband, the average noise level is subtracted from the composite signal, thus increasing the signal to noise ratio. If the noise is periodic, the analysis includes a Fourier analysis (or an equivalent frequency analysis technique). The periodic noise frequencies are then filtered from the range of possible signal frequencies.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates an optical system that incorporates the principles of the present invention;

FIG. 2 illustrates a time series response of an FBG sensor system subject to periodic noise; and

FIG. 3 illustrates the results of Fourier analysis and filtering of the time series response of FIG. 2;

FIG. 4 schematically illustrates an FBG sensor system that incorporates the principles of the present invention; and

FIG. 5 is a generalized flow chart that illustrates the principles of the present invention.

To facilitate understanding, identical reference numerals have been used, wherever possible, to designate identical elements that are common to the figures.

### DETAILED DESCRIPTION OF ILLUSTRATED EMBODIMENTS

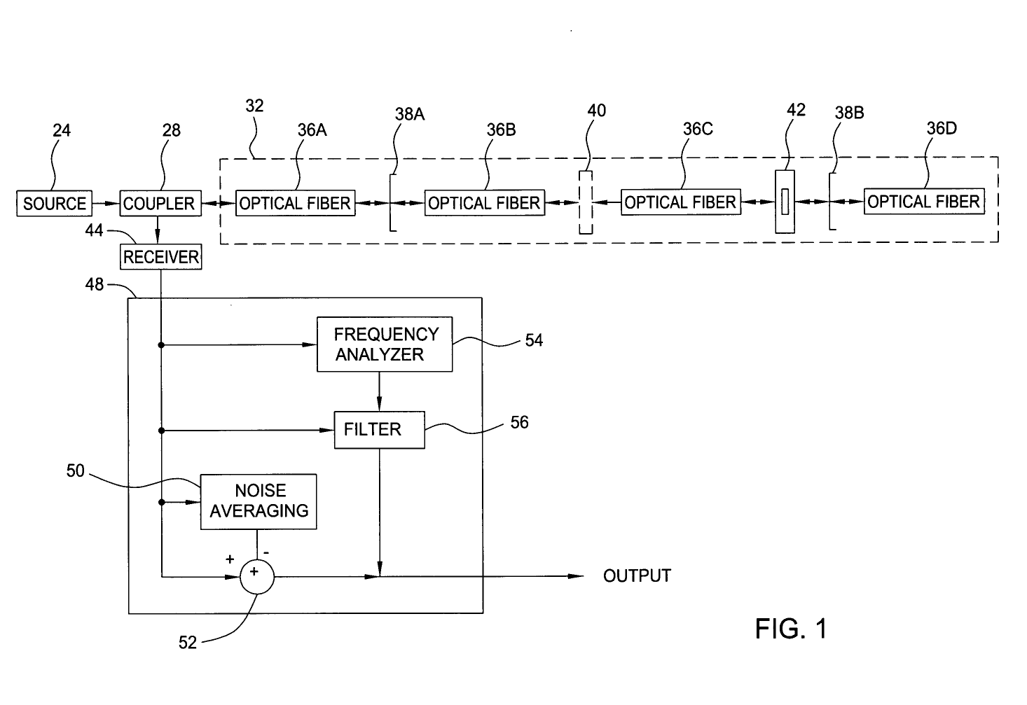

FIG. 1 illustrates a generalized apparatus 20 that is in accord with the principles of the present invention. That apparatus includes a light source for producing an optical signal, such as a scanning optical source 24 that produces a narrow bandwidth beam that sweeps across an optical spectrum. An optical signal produced by the optical source 24 is applied to a coupler 28 that couples the sweeping narrow bandwidth beam to an optical fiber network 32, e.g. an optical sensor array. The optical fiber network 32 includes multiple optical fiber sections, 36A-36D, which are coupled together by splices 38A and 38B and a connector 40. The splices 38A and 38B and the connector 40 represent discontinuities in the optical fiber network 32. The optical fiber network 32 also includes an FBG element 42. For simplicity, only one FBG element 42 is shown. Generally, the network 32 will comprise a plurality of FBG elements.

It should be understood that the subject invention is not limited to the use of optical fibers having FBG elements. Systems that use other types of optical waveguides and optical elements can also benefit from the present invention. Additionally, while the principles of the present invention can be used to reduce noise from the discontinuities, those principles also can be used to remove noise from other types of noise producing elements. In fact the present invention relates to a novel way of eliminating or reducing noise in general, and not to the noise source.

The FBG element 42 produces optical reflections when the bandwidth of the sweeping narrow bandwidth beam is very close to or at the Bragg wavelength of the FBG element 42. Furthermore, the splices 38A and 38B and the connector 40 produce reflections and reflections of reflections. The optical reflections from the FBG element 42 and the reflections from the splices 38A and 38B and the connector 40 that reach the coupler 28 are directed into a receiver 44. That receiver converts the optical reflections into electrical signals that are then amplified and applied to a noise reduction system 48.

The noise reduction system 48 reduces, removes, or cancels noise from the output of the receiver 44. There are two general classes of noise: broadband background noise and periodic noise. Background noise manifests itself as noise that exists over all or most of the optical spectrum of interest. For example, incoherent light that leaks into the apparatus 20 would produce broadband background noise. Such noise, if it exists, can be removed by averaging the noise over a wide bandwidth and then subtracting that noise from the receiver output. Period noise manifests itself as noise impulses in the received spectrum. Such periodic noise is removed by first identifying the noise impulses as periodic noise and then gating the periodic noise out of the received spectrum.

FIG. 1 illustrates a noise reduction system 48 that removes both broadband background noise and periodic noise. The broadband background noise is removed by applying the output of the receiver 44 to both a noise averaging network 50 and to a subtractor 52. The noise averaging network 50 averages the noise in the signal from the receiver 44, while the subtractor 52 subtracts the noise average from the signal from the receiver 44. The result in an output 52 having an improved signal to noise ratio.

The noise reduction system 48 further includes a frequency analyzer 54 that performs a frequency analysis e.g., a Fourier analysis or a similar type of analysis, of the receiver output. Periodic noise will produce a frequency spectrum that tends to produce more rapid oscillations in the optical spectrum while a Bragg wavelength, which represent reflections from the FBG element 42, are relatively stable. Once the frequency spectrum bandwidths having rapidly varying signals are identified by the frequency analyzer 54, a filtering circuit 56 gates the frequency spectrum bandwidths of the jumping signals out of the receiver output. The result is an optical signal output 52 without periodic noise.

It should clearly be understood that the broadband background noise, the periodic noise, or both, can be removed in a particular application.

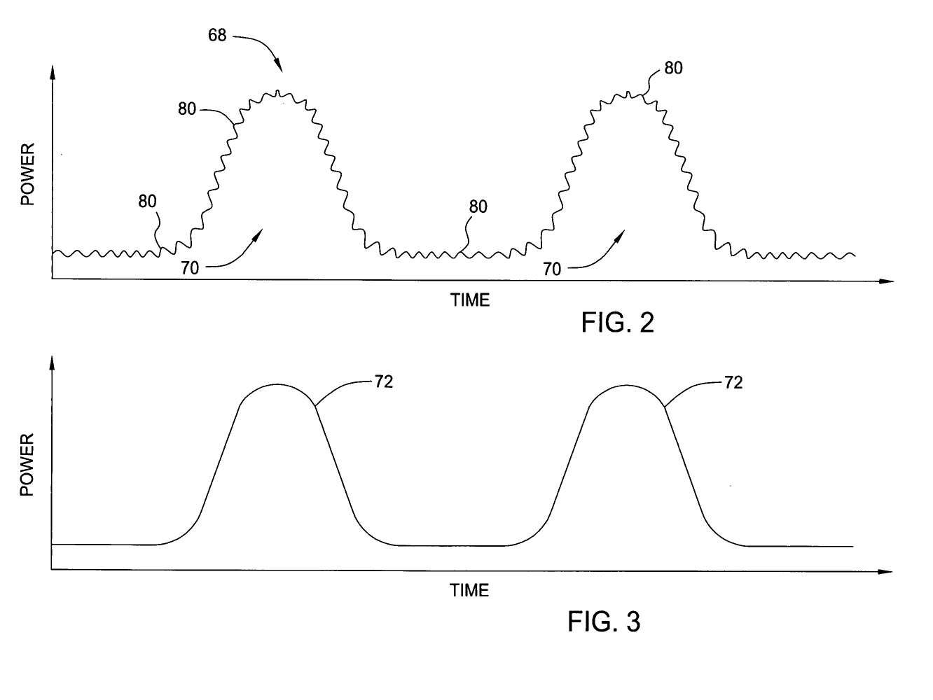

FIG. 2 illustrates an exemplary time series 68 that represents a wavelength sampled spectrum produced by the FBG and the scanning wavelength source. In particular, FIG. 2 shows a graph of the time series 68 response of two FBG at different Bragg wavelengths, 70 and 72, in the X-axis 74 and normalized amplitudes in the Y-axis 76. The time series 68 includes periodic noise 80 that rides atop of the stable FBG signal.

The noise reduction system 48 is used to block signals that occur in the time series 68 at unwanted temporal frequencies. The result is illustrated in FIG. 3, which shows the results of the periodic noise 80 being removed by the gating circuit 56, leaving only the Bragg wavelengths 70 and 72.

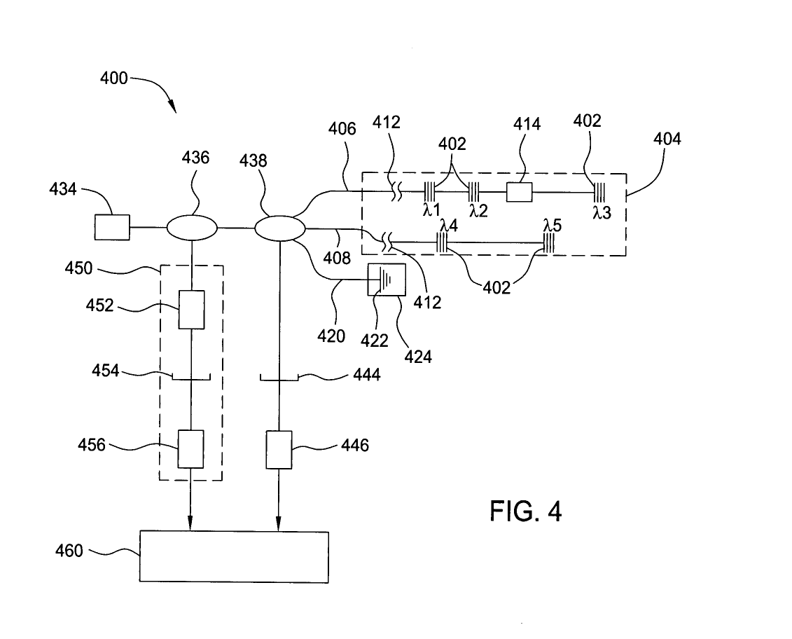

The principles of the present invention are well suited to FBG sensor systems, such as the FBG sensor system 400 illustrated in FIG. 4. The FBG sensor system 400 includes FBG elements 402 within an FBG sensor array 404. As shown, the FBG sensor array 404 may comprise one or more optical fibers 406 and 408, while the individual FBG elements 402 have Bragg wavelengths A1 through A5. The FBG sensor array 404 includes splices 412 and a connector 414 that produce periodic reflections. The FBG sensor system 400 is suitable for measuring pressure and temperature in hostile environments such as occurs in oil wells.

The FBG sensor system 400 could also include an optical fiber 420 having a reference FBG element 422 that is physically and thermally protected by an enclosure 424. The reference FBG element 422 is comprised of gratings that are induced in the core of the optical fiber 420. When light is applied to the reference FBG element 422 and to the FBG elements 402 reflections of light at Bragg wavelengths are produced. The enclosure 424 protects the reference FBG element 422 such that its Bragg wavelength is not susceptible to external influences.

The FBG sensor system 400 further includes a tunable laser 434 that is scanned across the Bragg wavelengths of the FBG elements 402 and of the reference FBG element 422. The tunable laser 434 corresponds to the source 24 of FIG. 1. The output of the tunable laser 434 is split by a fiber optic directional coupler or circulator 436. The main portion of the light is coupled to the FBG sensor array 404 and to the reference FBG element 422 via a second directional coupler or circulator 438. Thus, the combination of the fiber optic directional coupler 436 and the second directional coupler 438 correspond to the coupler 28 of FIG. 1.

Reflected light from the FBG sensor array 404, from the FBG element 422, which occur when the wavelength of the narrow bandwidth scanning light sweeps across the Bragg wavelength of an FBG element 402 or of the reference FBG element 422, and periodic reflections from the splices 412 and the connector 414 pass back to the directional coupler 438. The directional coupler 438 directs those reflections onto a sensor detector 444. The sensor detector 444 converts the reflections into sensor electrical signals having amplitudes that depend on the power (intensity) of the reflected light. The output of the sensor detector 444 is applied to a receiver 446 that amplifies the output of the sensor detector 444. Thus, the combination of the sensor detector 444 and the receiver 446 correspond to the receiver 44 of FIG. 1.

A portion of the light from the fiber optic directional coupler 436 is directed along a reference arm 450 having an interference filter 452, which is, for example, a fixed cavity F-P fiber filter. The interference filter 452 produces a reference spectrum having spectrum peaks with a constant, known frequency separation that depends on the interference filter 452. The reference spectrum is coupled to a reference detector 454 that produces a reference electrical pulse train. The output of the reference detector 454 is applied to a receiver 456 that amplifies the output of the reference detector 454.

Once the wavelength of one of the reference spectrum peaks is known, because of the constant frequency separation produced by the interference filter 452 all of the wavelengths of the reference spectrum peaks can be determined. Then, by comparing the Bragg wavelengths of the FBG elements 402 to the wavelengths of the reference spectrum peaks the Bragg wavelengths of the FBG elements can be accurately determined. Furthermore, since the unstressed Bragg wavelengths of the FBG elements 402 are known, the wavelength change in each FBG element's Bragg wavelength can be used to determine a physical parameter of interest.

To that end, the electrical signals from the receiver 446 and from the receiver 456 are sequentially sampled, processed and compared in a signal processor 460 to produce such measurements. That unit interrogates the reference electrical signals to isolate the response from the reference FBG element 422 (which is different than the wavelengths A1 through A5). That response is processed to determine the characteristic wavelength of the reference FBG element 422. That characteristic wavelength is then used to identify at least one reference peak, which together with the known reference peak spacing, are used as to determine the Bragg wavelengths A1 through A5.

A key to accurately determining the Bragg wavelengths A1 through A5 is accurately determining the characteristic Bragg wavelength of the reference FBG element 422. To achieve that goal, the signal processor 460 removes electrical noise from the output of the receiver 446 as described above. The signal processor 460 can subtract an averaged noise level from the electrical signals and/or perform a Fourier analysis. The results of the Fourier analysis can then be used to gate out periodic noise. Either way the signal to noise ratio is improved, which enables a more accurate determination of the characteristic Bragg wavelength of the reference FBG element 422, and thus a more accurate determination of the Bragg wavelengths A1 through A5.

It should be noted that the foregoing process can be repeated over the life of the FBG sensor array 404 to correct for time-induced changes.

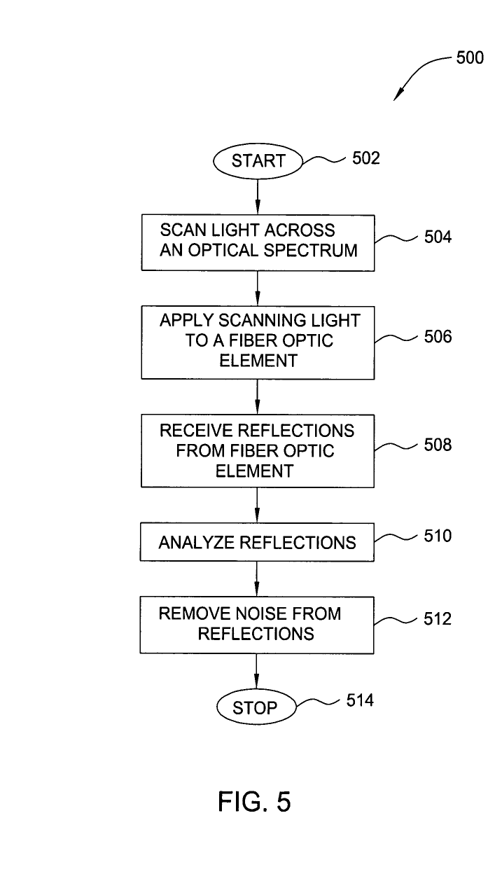

FIG. 5 is a generalized flow chart 500 that illustrates the principles of the present invention. The process starts at step 502 and proceeds at step 504 by scanning narrowband light across a frequency spectrum. At step 506, the scanning narrowband light is applied to a fiber optic element. At step 508, reflections are received from the fiber optic element. At step 510, the received reflections are then analyzed to determine the background noise and/or the Fourier components of the noise components. Then, at step 512, the noise components of the reflections are then removed, either by averaging the noise and then subtracting the average from the reflected signals, or the noise bandwidths are gated out. Finally, the process stops at step 514.

While the foregoing is directed to embodiments of the present invention, other and further embodiments of the invention may be devised without departing from the basic scope thereof, and the scope thereof is determined by the claims that follow.

1. An optical system comprising:
a source for producing optical signals;
an optical waveguide having a noise producing element and an optical filter element;
a receiver for converting applied optical signals into electrical signals;
a coupler for coupling said produced optical signals into said optical waveguide and for coupling reflections from said noise producing element and from said optical filter element to said receiver as applied optical signals; and
a noise reduction system for removing noise produced by said noise producing element from said electrical signals.

2. The system of claim 1 wherein the noise reduction system averages broadband noise and then subtracts the averaged level from the electrical signals.

3. The system of claim 1 wherein the noise reduction system performs a frequency analysis of the electrical signals to identify periodic noise.

4. The system of claim 3 wherein the noise reduction system further removes the periodic noise from the electrical signals.

5. The system of claim 4 wherein the noise reduction system removes the periodic noise by gating the periodic noise out of the electrical signals.

6. The system of claim 3 wherein the frequency analysis is a Fourier analysis.

7. The system of claim 5 wherein the noise reduction system averages broadband noise and then subtracts the averaged level from the electrical signals.

8. The system of claim 1 wherein the optical filter element includes a fiber Bragg grating.

9. The system of claim 1 wherein the optical waveguide includes a discontinuity.

10. The system of claim 1 wherein the discontinuity is a splice.

11. A sensor comprising:
a source for producing optical signals;
an optical waveguide having a noise producing element and an optical filter element;
a receiver for converting applied optical signals into amplified electrical signals;
a coupler for coupling said produced optical signals into said optical waveguide and for coupling reflections from said optical waveguide as applied optical signals to said receiver; and
a signal processor for removing noise produced by said noise producing element from said electrical signals.

12. The sensor of claim 11 wherein said signal processor subtracts an averaged noise level from the electrical signals.

13. The sensor of claim 11 wherein said signal processor performs a frequency analysis of the electrical signals to identify and remove periodic noise from the electrical signals.

14. The sensor of claim 13 wherein the frequency analysis is a Fourier analysis.

15. The sensor of claim 13 wherein said signal processor subtracts an averaged noise level from the electrical signals.

16. The sensor of claim 11 wherein the source includes a tunable laser.

17. The sensor of claim 11 wherein the source includes a broadband light source and a tunable filter.

18. The system of claim 11 wherein the optical filter element includes a fiber Bragg grating.

19. The system of claim 11 wherein the optical waveguide includes a discontinuity.

20. The system of claim 11 wherein the discontinuity is a splice.

21. A method of compensating for optical reflection comprising:
producing an optical signal;
coupling the optical signal into an optical waveguide having a noise producing element and an optical filter element;
converting reflections along the optical waveguide into electrical signals; and
removing noise produced by the noise producing element from the electrical signals such that the electrical signals from the optical filter element are retained.

22. The method of claim 21 wherein removing noise includes finding an average noise level and subtracting that average noise level from the electrical signals.

23. The method of claim 21 wherein removing noise includes performing a frequency analysis and then gating out noise produced by the noise producing element from the electrical signals.

24. The method of claim 22 wherein removing noise includes performing a frequency analysis and then gating out noise produced by the noise producing element from the electrical signals.
